(19) United States
(12) Patent Application Publication
(10) Pub. No.: US 2024/0054627 A1
(43) Pub. Date: Feb. 15, 2024

(54) Vehicle and Control Method Thereof

(71) Applicants: Hyundai Motor Company, Seoul (KR); Kia Corporation, Seoul (KR)

(72) Inventor: Kyeongseob Song, Seoul (KR)

(21) Appl. No.: 18/318,180

(22) Filed: May 16, 2023

(30) Foreign Application Priority Data
Aug. 11, 2022 (KR) 10-2022-0100895

(51) Int. Cl. G06T 7/00; G06V 10/25; G06V 20/56; B60W 60/00

(52) U.S. Cl. CPC G06T 7/0002; G06V 10/25; G06V 20/56; B60W 60/001; G06T 2207/30252; G06V 2201/08; G06T 2207/20076; B60W 2420/42

(57) ABSTRACT

An embodiment vehicle includes a camera, a preprocessor configured to set a region of interest (ROI) in an image of an area outside the vehicle obtained by the camera, an image processor configured to obtain an illuminance value of a pixel belonging to the ROI in each frame of the image, and a determination unit configured to determine whether or not each frame of the image has low illuminance based on the illuminance value.

### CROSS-REFERENCE TO RELATED APPLICATIONS

This application claims the benefit of Korean Patent Application No. 10-2022-0100895, filed on Aug. 11, 2022, which application is hereby incorporated herein by reference.

### TECHNICAL FIELD

The disclosure relates to a vehicle and a control method thereof.

### BACKGROUND

Multiple multi-cameras are necessarily mounted on a vehicle equipped with an autonomous driving system or an advanced driver assistance system (ADAS), and the vehicle recognizes an object through the cameras and obtains information related to the object.

The ADAS and the autonomous driving system are common in recognizing an object based on a camera, but in an autonomous driving system in which there is little driver intervention, it is necessary to secure performance capable of distinguishing and accurately recognizing various objects.

In an autonomous driving situation, there are bound to be limitations in image recognition. For example, during autonomous driving, a situation may occur in which water forms on a camera, a part of a lens is covered by dirt splashing, or it is difficult to recognize an object or space due to light rays.

In addition, there may be a situation in which image recognition performance is unreliable due to low illuminance. Image recognition performance is unreliable in situations such as autonomous driving at night when a light source is insufficient and autonomous parking in an indoor/underground parking lot with poor lighting.

### SUMMARY

An embodiment of the disclosure provides a vehicle and a control method thereof capable of determining whether or not an illumination environment is in low illuminance in autonomous driving and parking situations and allowing a driver or user to pay more attention without unconditionally trusting image recognition performance when it is determined that the illumination environment is in low illuminance, thereby securing a safe autonomous driving and parking system.

Additional embodiments of the disclosure will be set forth in part in the description which follows and, in part, will be obvious from the description, or may be learned by practice of the disclosure.

In accordance with an embodiment of the disclosure, a vehicle includes a camera configured to obtain an external image of the vehicle, a preprocessor configured to set a region of interest (ROI) in the image obtained by the camera, an image processor configured to obtain an illuminance value of a pixel belonging to the ROI in each frame of the image, and a determination unit configured to determine whether or not each frame of the image has low illuminance based on the illuminance value.

The image processor may generate a cumulative distribution function for illuminance values and probability values for all pixels of the ROI in each frame of the image, and the determination unit may determine whether or not each frame of the image has low illuminance based on the cumulative distribution function.

The image processor may determine a plurality of pairs of illuminance values and probability values capable of determining whether or not the image has low illuminance from the cumulative distribution function, and the determination unit may determine whether or not each frame of the image has low illuminance based on the plurality of pairs of illuminance values and probability values.

The image processor may set, as the ROI, a region excluding a region where a body of the vehicle is visible in the image obtained by the camera.

The image processor may limit an upper limit value of the illuminance values included in the cumulative distribution function to a predetermined value.

The image processor may multiply an illuminance value of a region located within a predetermined distance from the vehicle in the image by a first value greater than 1.

The image processor may multiply an illuminance value of an upper region of the image as much as a predetermined first ratio by a second value less than 1.

The vehicle may further include a postprocessor configured to determine whether or not each frame of the image has low illuminance based on an emergency light blinking period of the vehicle.

The image processor may determine a ratio of frames determined to be low illuminance among a plurality of frames included in a time as much as the emergency light blinking period of the vehicle prior to a specific frame of the image, and determine whether or not the specific frame has low illuminance based on the determination result.

When the ratio of frames determined to be low illuminance for the time as much as the emergency light blinking period of the vehicle prior to the specific frame is equal to or greater than a predetermined second ratio, the postprocessor may determine that the specific frame has low illuminance.

In accordance with an embodiment of the disclosure, a control method of a vehicle includes obtaining an external image of the vehicle, setting a region of interest (ROI) in the obtained image, obtaining an illuminance value of a pixel belonging to the ROI in each frame of the image, and determining whether or not each frame of the image has low illuminance based on the illuminance value.

The control method may further include generating a cumulative distribution function for illuminance values and probability values for all pixels of the ROI in each frame of the image, wherein the determining of whether or not each frame of the image has low illuminance may include determining whether or not each frame of the image has low illuminance based on the cumulative distribution function.

The control method may further include determining a plurality of pairs of illuminance values and probability values capable of determining whether or not the image has low illuminance from the cumulative distribution function, wherein the determining of whether or not each frame of the image has low illuminance may include determining whether or not each frame of the image has low illuminance based on the plurality of pairs of illuminance values and probability values.

The setting of the ROI may include setting, as the ROI, a region excluding a region where a body of the vehicle is visible in the obtained image.

The generating of the cumulative distribution function may include limiting an upper limit value of the illuminance values included in the cumulative distribution function to a predetermined value.

The control method may further include multiplying an illuminance value of a region located within a predetermined distance from the vehicle in the image by a first value greater than 1.

The control method may further include multiplying an illuminance value of an upper region of the image as much as a predetermined first ratio by a second value less than 1.

The control method may further include determining whether or not each frame of the image has low illuminance based on an emergency light blinking period of the vehicle.

The determining of whether or not each frame of the image has low illuminance based on the emergency light blinking period of the vehicle may include determining a ratio of frames determined to be low illuminance among a plurality of frames included in a time as much as the emergency light blinking period of the vehicle prior to a specific frame of the image, and determining whether or not the specific frame has low illuminance based on the determination result.

The determining of whether or not each frame of the image has low illuminance based on the emergency light blinking period of the vehicle may include determining that the specific frame has low illuminance when the ratio of frames determined to be low illuminance for the time as much as the emergency light blinking period of the vehicle prior to the specific frame is equal to or greater than a predetermined second ratio.

### BRIEF DESCRIPTION OF THE DRAWINGS

These and/or other features of embodiments of the disclosure will become apparent and more readily appreciated from the following description of the embodiments, taken in conjunction with the accompanying drawings, in which:

FIG. 1 is a view illustrating a camera unit mounted on a vehicle according to an embodiment;

FIG. 2 is a control block diagram of the vehicle according to an embodiment;

FIG. 3 is a graph illustrating a cumulative distribution function for illuminance values and probability values according to an embodiment;

FIG. 4 is a graph illustrating a case of a non-low illuminance environment according to an embodiment;

FIG. 5 is a graph illustrating a case of a low-illuminance environment according to an embodiment;

FIG. 6 is a diagram illustrating a viewpoint of a side camera according to an embodiment;

FIG. 7 is a graph illustrating a limitation of an upper limit of the cumulative distribution function according to an embodiment;

FIG. 8 is a diagram for explaining weighting impartment depending on a field of view range of the camera and a light source according to an embodiment;

FIG. 9 is a control block diagram of the vehicle according to an embodiment;

FIG. 10 is a diagram for illustrating that an emergency light blinking period is considered according to an embodiment; and

FIG. 11 is a flowchart of a control method of the vehicle according to an embodiment.

### DETAILED DESCRIPTION OF ILLUSTRATIVE EMBODIMENTS

Throughout the specification, like reference numerals refer to like elements. This specification does not describe all components of embodiments, and duplicative contents between general contents or embodiments in the technical field of the disclosure will be omitted. The terms ‘member,’ ‘module,’ and ‘device’ used in this specification may be embodied as software or hardware, and it is also possible for a plurality of ‘members,’ modules; and ‘devices’ to be embodied as one component, or one ‘member,’ module; and ‘device’ to include a plurality of components according to the embodiments.

The configurations shown in the embodiments and drawings described in this specification are preferred examples of the disclosure, and there may be various modifications that may replace the embodiments and drawings in this specification at the time of filing of the present application.

The terms used herein are for the purpose of describing the embodiments and are not intended to restrict and/or to limit the disclosure. For example, the singular expressions herein may include plural expressions, unless the context clearly dictates otherwise. Also, the terms “comprises,” “includes,” “has,” and the like are intended to indicate that there are features, numbers, steps, operations, elements, parts, or combinations thereof described in the specification, and do not exclude the presence or addition of one or more other features, numbers, steps, operations, elements, parts, or combinations thereof.

In addition, terms such as “—unit”, “—part,” “—block,” “—member,” “—module,” and the like may denote a unit for processing at least one function or operation. For example, the terms may refer to at least one hardware such as a field-programmable gate array (FPGA)/an application specific integrated circuit (ASIC), at least one software stored in a memory, or at least one process processed by a processor.

The terms ‘first,’ ‘second,’ etc. are used to distinguish one element from another element, and the elements are not limited by the above-mentioned terms.

In each step, an identification numeral is used for convenience of explanation, the identification numeral does not describe the order of the steps, and each step may be performed differently from the order specified unless the context clearly states a particular order.

The disclosed embodiments may be implemented in the form of a recording medium storing instructions executable by a computer. The instructions may be stored in the form of program code, and when executed by a processor, a program module may be created to perform the operations of the disclosed embodiments. The recording medium may be implemented as a computer-readable recording medium.

The computer-readable recording medium includes any type of recording medium in which instructions readable by the computer are stored. For example, the recording medium may include a read only memory (ROM), a random access memory (RAM), a magnetic tape, a magnetic disk, a flash memory, an optical data storage device, and the like.

Hereinafter, embodiments of a user interface device according to an aspect, a vehicle having the same, and a control method thereof will be described in detail with reference to the accompanying drawings.

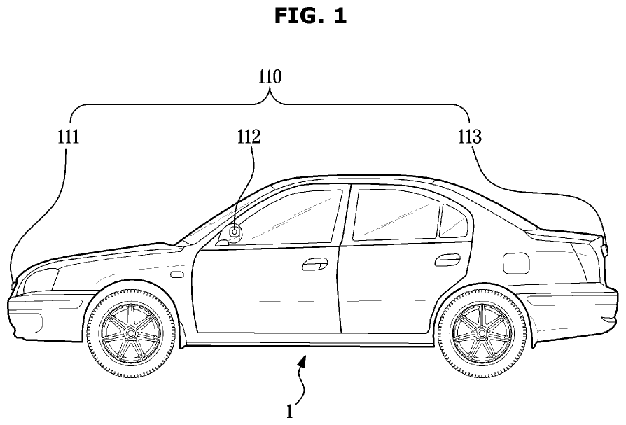

FIG. 1 is a view illustrating a camera unit mounted on a vehicle according to an embodiment.

A vehicle 1 may include a camera unit no to implement an autonomous driving system, and the camera unit no may include a front camera in, side cameras 112, and a rear camera 113.

Although only the cameras are illustrated in FIG. 1, a radar and a lidar are mounted together in addition to the cameras, so that an object may be recognized using a sensor fusion method.

The front camera 111 may be installed on a front windshield or a front bumper to secure a field of view facing the front of the vehicle 1. In this case, the front camera 111 may detect a moving object in a front field of view or an obstacle in a front side field of view. The front camera 111 transmits an image signal obtained from the front field of view to a processor to cause the processor to process front image data.

The side cameras 112 may be symmetrically installed on B-pillars or the like to secure a field of view facing lateral sides of the vehicle 1. The side cameras 112 are provided on left and right sides of the vehicle 1 and may detect moving objects traveling side by side at sides of the vehicle 1 or pedestrians approaching the vehicle 1. The side camera 112 transmits an image signal obtained from a lateral field of view to the processor to cause the processor to process lateral image data.

The rear camera 113 may be installed on a rear windshield or a rear bumper to secure a field of view facing the rear of the vehicle 1. In this case, the rear camera 113 may detect a moving object in a rear field of view or an obstacle in a rear side field of view. The rear camera 113 transmits an image signal obtained from the rear field of view to the processor to cause the processor to process rear image data.

As described above, the camera unit no is exemplified as including a total of four cameras, but is not limited thereto, and may include more cameras such as 6 cameras, 8 cameras, and 12 cameras to improve recognition performance. In addition, a location of each of the cameras may of course be changed to secure an optimal field of view depending on a structure of the vehicle 1.

The camera unit no may include a plurality of lenses and an image sensor. The camera unit no may secure all omnidirectional fields of view with respect to the vehicle 1 by being implemented as wide-angle cameras.

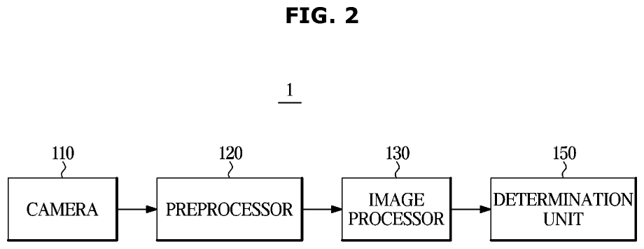

FIG. 2 is a control block diagram of the vehicle according to an embodiment.

The vehicle 1 may further include a preprocessor 120, an image processor 130, and a determination unit 150 in addition to the camera unit no described above.

The preprocessor 120 may process image data obtained from the camera unit 110. For example, the preprocessor 120 may set a region of interest (ROI) for an image obtained by the camera unit 110.

The image processor 130 may obtain an illuminance value of a pixel belonging to the ROI in each frame of the image obtained by the camera unit 110.

In addition, the image processor 130 may generate a cumulative distribution function for illuminance values and probability values for all pixels of the ROI in each frame of the image.

The determination unit 150 may determine whether or not each frame of the image has low illuminance based on the illuminance value.

When it is determined that a specific frame is low illuminance depending on the low illuminance determination, the determination unit 150 may not trust a recognition result of the image including such a frame.

The determination unit 150 may prevent the occurrence of control based on the recognition result different from an actual one by not trusting the recognition result of the image obtained in a low-illuminance environment.

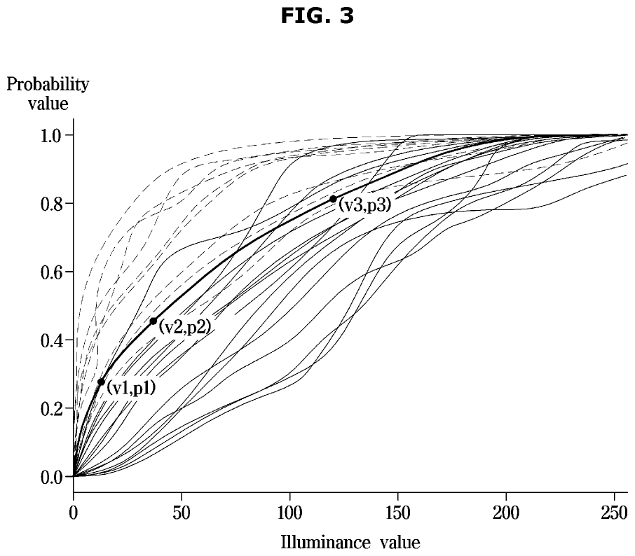

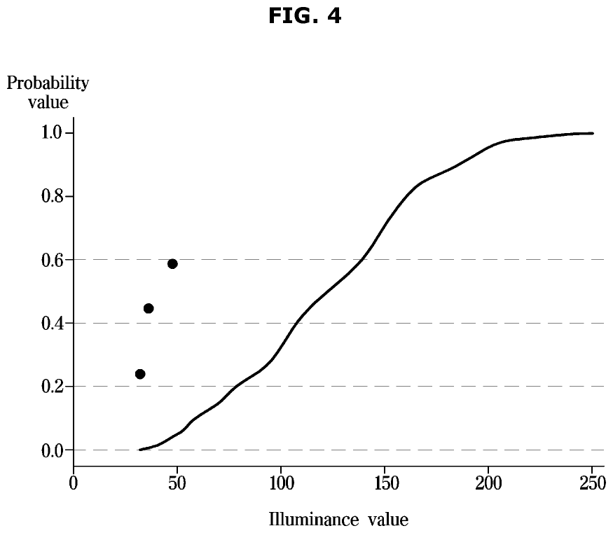

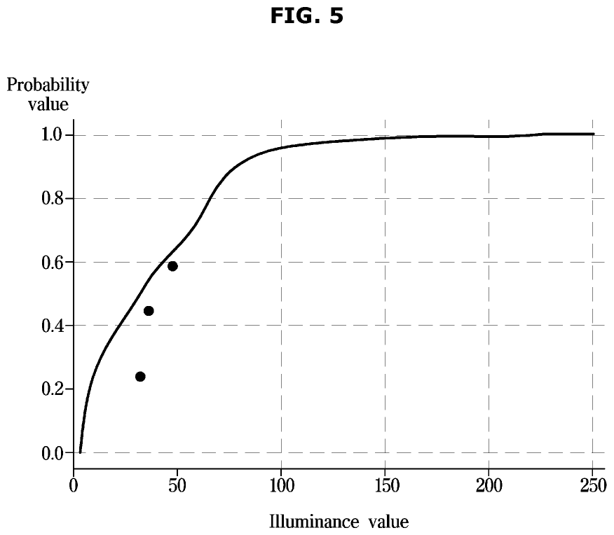

FIG. 3 is a graph illustrating a cumulative distribution function for illuminance values and probability values according to an embodiment, and FIGS. 4 and 5 are graphs for explaining determination of low illuminance from a plurality of pairs according to the cumulative distribution function.

The image processor 130 may generate a cumulative distribution function for illuminance values and probability values for all pixels of the ROI in each frame of the image, and the determination unit 150 may determine whether or not each frame of the image has low illuminance based on the cumulative distribution function.

Specifically, the image processor 130 may determine a plurality of pairs of illuminance values and probability values capable of determining whether or not the image has low illuminance from the cumulative distribution function.

Referring to FIG. 3, a portion indicated by a solid line represents a distribution function for a frame in a non-low illuminance environment, and a portion indicated by a dotted line represents a distribution function for a frame in a low-illuminance environment.

The image processor 130 may determine a plurality of pairs of illuminance values and probability values capable of determining low illuminance of an image at a boundary between the portion indicated by the solid line and the portion indicated by the dotted line.

Taking FIG. 3 as an example, pairs (v1, p1), (v2, p2) and (v3, p3) may be determined.

FIG. 3 shows that three pairs are determined, but this is only an example, and there is no limit to the number of pairs of illuminance values and probability values as long as it is possible to determine whether or not an image has low illuminance.

The determination unit 150 may determine whether or not each frame of the image has low illuminance based on the plurality of pairs of illuminance values and probability values.

Referring to FIG. 4, it may be seen that the distribution function for the illuminance values and the probability values of the frame is positioned to the right of the pairs (v1, p1), (v2, p2), and (v3, p3).

Accordingly, the determination unit 150 may determine that the corresponding frame does not have low illuminance.

Referring to FIG. 5, it may be seen that the distribution function for the illuminance values and the probability values of the frame is positioned to the left of the pairs (v1, p1), (v2, p2), and (v3, p3).

Accordingly, the determination unit 150 may determine that the corresponding frame has low illuminance.

In this way, a cumulative distribution function is generated so that a plurality of pairs of illuminance values and probability values is determined, and thus whether or not each frame has low illuminance may be determined.

A frame determined to have low illuminance may not be used in image recognition because it is determined to be unreliable in image recognition.

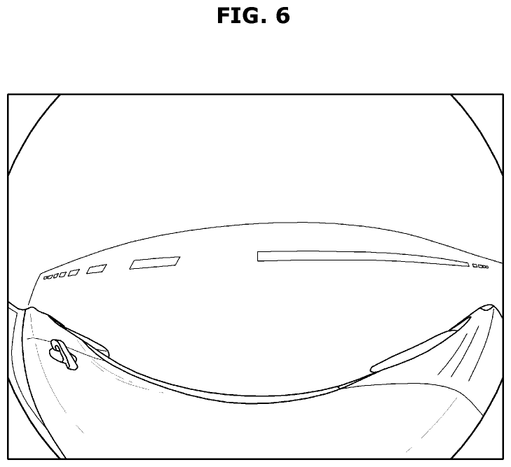

FIG. 6 is a diagram illustrating a viewpoint of a side camera according to an embodiment.

As described above, the preprocessor 120 may set the ROI in the image obtained by the camera unit 110.

Specifically, the preprocessor 120 may set as the ROI a region excluding a region where a body of the vehicle 1 is visible in the image obtained by the camera unit 110.

When a cumulative distribution function for a frame is generated, an unreliable result may be output when it is affected by a change in illuminance caused by the body of the vehicle 1.

Accordingly, the preprocessor 120 may generate a cumulative distribution function only for parts other than the vehicle body by excluding the region where the vehicle body is visible in the image obtained by the camera unit 110.

In this case, a masking filter module may be applied so that the cumulative distribution function is not generated for a portion where the vehicle body is visible.

As illustrated in FIG. 6, a portion other than a portion where a side of the vehicle 1 is visible at a lower end of the image is set as an ROI, and a cumulative distribution function may be generated only for the corresponding ROI.

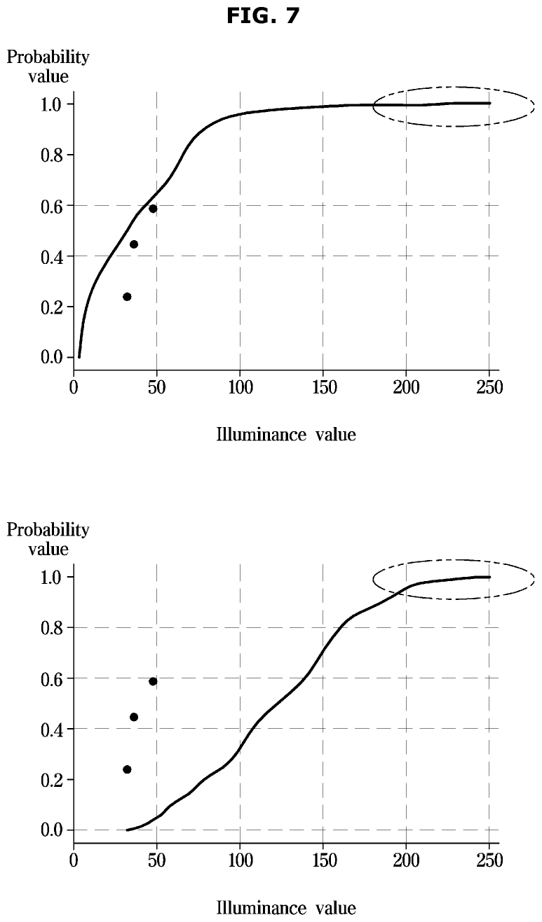

FIG. 7 is a graph illustrating a limitation of an upper limit of the cumulative distribution function according to an embodiment.

When a separate light source exists in an image captured by the camera unit 110, that is, when a light source such as a street light and a fluorescent lamp is captured by the camera unit 110, the light source may have a great influence on determining low illuminance, and it is desirable to exclude the light source when determining low illuminance.

As a result of analyzing illuminance values of ordinary light sources, most of the light sources are detected in regions where the illuminance value exceeds 200, so that the preprocessor 120 may limit an upper limit value of illuminance values included in the cumulative distribution function to a predetermined value.

That is, an upper limit of a range of illuminance values accumulated in the cumulative distribution function may be limited. Herein, the predetermined value may be 200, which is an illuminance value detected from most of the light sources.

As illustrated in FIG. 7, an error caused by a separate light source affecting low illuminance determination may be prevented by not including a portion having an illuminance value of more than 200 in the cumulative distribution function.

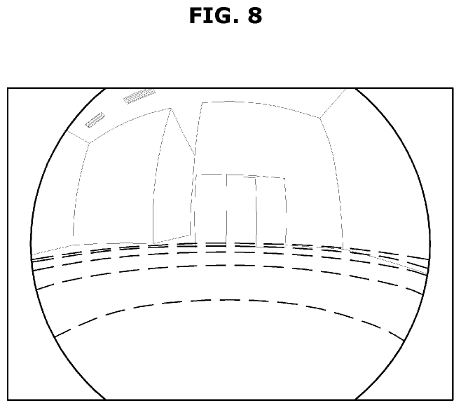

FIG. 8 is a diagram for explaining weighting impartment depending on a field of view range of the camera and a light source according to an embodiment.

In image recognition, because it is determined that an object and a space located within a close distance from the vehicle 1 are more important than an object and a space located at a distance, it is necessary to impart a weighting to an object and a space located within a certain distance from the vehicle 1.

Accordingly, the preprocessor 120 may multiply an illuminance value of a region located within a predetermined distance from the vehicle 1 in an image by a first value greater than 1. Herein, the predetermined distance may be 3 m, and the first value may be 1.2.

By imparting a weighting to an illuminance value of the region located within the predetermined distance from the vehicle 1 to give a higher weight, a more accurate determination may be made with respect to a relatively more important object and space located at a short distance.

In addition, a separate light source (indoor ceiling light, street light, sky, etc.) is frequently located in a space located at an upper end of the captured image. Because such a separate light source affects the determination of low illuminance, it is necessary to minimize the illuminance value due to this light source.

Accordingly, the preprocessor 120 may multiply a second value smaller than 1 to the illuminance value of an upper region of the image as much as a predetermined first ratio. The first ratio may refer to 10%, that is, the upper region corresponding to 10% of the image, and the second value may refer to 0.8.

By imparting a weighting to an illuminance value of the region located in the upper space of the captured image to give a lower weight, a more accurate determination may be made by minimizing the influence of a separate light source.

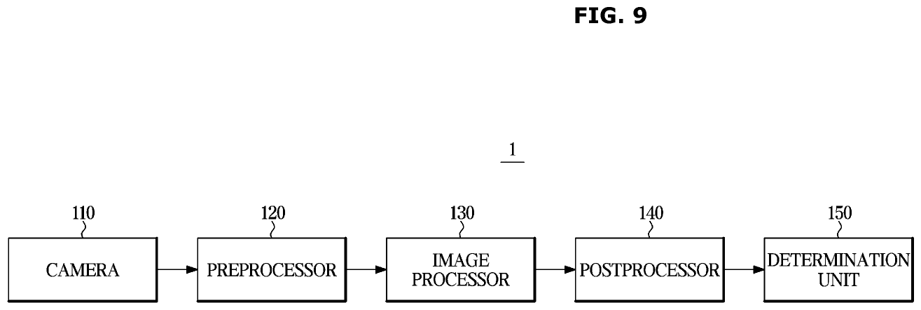

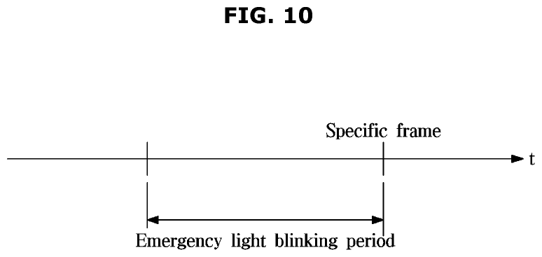

FIG. 9 is a control block diagram of the vehicle according to an embodiment, and FIG. 10 is a diagram for illustrating that an emergency light blinking period is considered according to an embodiment.

The vehicle 1 may further include a postprocessor 140 to determine whether or not each frame of the image has low illuminance based on an emergency light blinking period of the vehicle 1.

There may be a frame in which the illuminance increases momentarily in a low illuminance situation. For example, in a situation such as turning on an emergency light in a low illuminance environment or passing under a street lamp, the illuminance may increase momentarily.

At this time, when it is determined that the frame at the moment is not in the low illuminance environment, a reliable result may not be obtained in image recognition. That is, in this situation, it may be reasonable to finally determine the illuminance in consideration of the context of the illuminance of the environment.

Because emergency light blinking of the vehicle 1 is performed at a certain period, whether or not there is low illuminance of a specific frame may be finally determined in consideration of this.

Therefore, the postprocessor 140 may determine a ratio of frames determined to be low illuminance among a plurality of frames included in a time as much as the emergency light blinking period of the vehicle 1 prior to the specific frame of the image, and may determine whether or not the specific frame has low illuminance based on a determination result.

Specifically, when the ratio of frames determined to be low illuminance for the time as much as the emergency light blinking period of the vehicle 1 prior to the specific frame is equal to or greater than a predetermined second ratio, the postprocessor 140 may determine that the specific frame has low illuminance.

For example, when the emergency light blinking period of the vehicle 1 is 2 seconds, the postprocessor 140 may determine the ratio of frames determined to be low illuminance for 2 seconds prior to the specific frame.

Herein, the predetermined second ratio may be 40%, and accordingly, when the ratio of frames determined to be low illuminance for 2 seconds prior to the specific frame is 40% or more, the postprocessor 140 may determine that the specific frame has low illuminance.

Conversely, when the ratio of frames determined to be low illuminance for 2 seconds prior to the specific frame is less than 40%, the postprocessor 140 may determine that the specific frame does not correspond to a low illuminance environment.

That is, as such, a more reliable result may be obtained by finally determining whether or not there is low illuminance in consideration of the context of the illuminance of the environment.

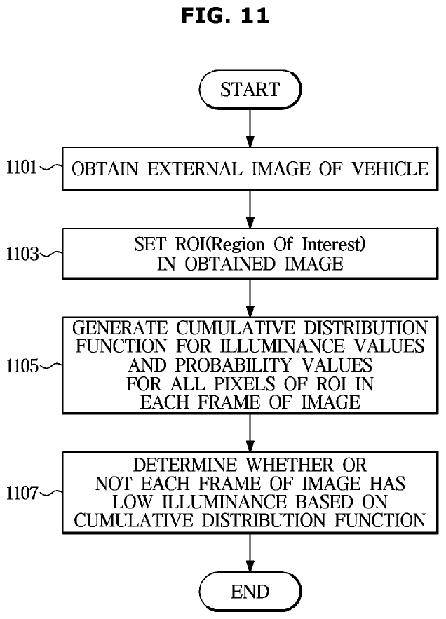

FIG. 11 is a flowchart of a control method of the vehicle according to an embodiment.

When an external image of the vehicle 1 is obtained from the camera unit no (1101), the preprocessor 120 may process an image data obtained from the camera unit no. For example, the preprocessor 120 may set a region of interest (ROI) for an image obtained by the camera unit no (1103).

The image processor 130 may obtain illuminance values of a pixel belonging to the ROI in each frame of the image obtained by the camera unit no and may also generate a cumulative distribution function for illuminance values and probability values for all pixels of the ROI in each frame of the image.

The determination unit 150 may determine whether or not each frame of the image has low illuminance based on the illuminance values.

Specifically, the image processor 130 may generate a cumulative distribution function for the illuminance values and probability values for all pixels of the ROI in each frame of the image (1105), and the determination unit 150 may determine whether or not each frame of the image has low illuminance based on the cumulative distribution function (1107).

Specifically, the image processor 130 may determine a plurality of pairs of illuminance values and probability values capable of determining whether or not the image has low illuminance from the cumulative distribution function, and the determination unit 150 may determine whether or not each frame of the image has low illuminance based on the plurality of pairs of illuminance values and probability values.

In this way, a cumulative distribution function may be generated and a plurality of pairs of illuminance values and probability values may be determined accordingly, and accordingly, whether or not each frame has low illuminance may be determined.

A frame determined to have low illuminance may not be used in image recognition because it is determined to be unreliable in image recognition.

As is apparent from the above, a vehicle and a control method thereof according to embodiments of the disclosure can determine whether or not an illumination environment is in low illuminance in autonomous driving and parking situations and allow a driver or user to pay more attention without unconditionally trusting image recognition performance when it is determined that the illumination environment is in low illuminance, thereby securing a safe autonomous driving and parking system.

The embodiments disclosed with reference to the accompanying drawings have been described above. It will be understood by those skilled in the art that various changes in form and details may be made therein without departing from the spirit and scope of the disclosure as defined by the appended claims. The disclosed embodiments are illustrative and should not be construed as limiting.

What is claimed is:

1. A vehicle comprising:
a camera;
a preprocessor configured to set a region of interest (ROI) in an image of an area outside the vehicle obtained by the camera;
an image processor configured to obtain an illuminance value of a pixel belonging to the ROI in each frame of the image; and
a determination unit configured to determine whether or not each frame of the image has low illuminance based on the illuminance value.

2. The vehicle according to claim 1, wherein:
the image processor is configured to generate a cumulative distribution function for illuminance values and probability values for all pixels of the ROI in each frame of the image; and
the determination unit is configured to determine whether or not each frame of the image has low illuminance based on the cumulative distribution function.

3. The vehicle according to claim 2, wherein:
the image processor is configured to determine a plurality of pairs of illuminance values and probability values capable of assisting in determining whether or not the image has low illuminance from the cumulative distribution function; and
the determination unit is configured to determine whether or not each frame of the image has low illuminance based on the plurality of pairs of illuminance values and probability values.

4. The vehicle according to claim 2, wherein the preprocessor is configured to limit an upper limit value of the illuminance values included in the cumulative distribution function to a predetermined value.

5. The vehicle according to claim 2, wherein the preprocessor is configured to multiply an illuminance value of a region located within a predetermined distance from the vehicle in the image by a first value greater than 1.

6. The vehicle according to claim 2, wherein the preprocessor is configured to multiply an illuminance value of an upper region of the image as much as a predetermined first ratio by a second value less than 1.

7. The vehicle according to claim 2, further comprising a postprocessor configured to determine whether or not each frame of the image has low illuminance based on an emergency light blinking period of the vehicle.

8. The vehicle according to claim 7, wherein the postprocessor is configured to:
determine a ratio of frames determined to be low illuminance among a plurality of frames included in a set time prior to a specific frame of the image, wherein the set time is less than or equal to the emergency light blinking period of the vehicle; and
determine whether or not the specific frame has low illuminance based on the determination result.

9. The vehicle according to claim 8, wherein, when the ratio of frames determined to be low illuminance for the set time prior to the specific frame is equal to or greater than a predetermined second ratio, the postprocessor is configured to determine that the specific frame has low illuminance.

10. The vehicle according to claim 1, wherein the preprocessor is configured to set, as the ROI, a region excluding a region where a body of the vehicle is visible in the image obtained by the camera.

11. A control method of a vehicle, the control method comprising:
obtaining an image of an area outside the vehicle;
setting a region of interest (ROI) in the image;
obtaining an illuminance value of a pixel belonging to the ROI in each frame of the image; and
determining whether or not each frame of the image has low illuminance based on the illuminance value.

12. The control method according to claim 11, further comprising generating a cumulative distribution function for illuminance values and probability values for all pixels of the ROI in each frame of the image, wherein determining whether or not each frame of the image has low illuminance comprises determining whether or not each frame of the image has low illuminance based on the cumulative distribution function.

13. The control method according to claim 12, further comprising determining a plurality of pairs of illuminance values and probability values capable of assisting in determining whether or not the image has low illuminance from the cumulative distribution function, wherein determining whether or not each frame of the image has low illuminance comprises determining whether or not each frame of the image has low illuminance based on the plurality of pairs of illuminance values and probability values.

14. The control method according to claim 12, wherein generating the cumulative distribution function comprises limiting an upper limit value of the illuminance values included in the cumulative distribution function to a predetermined value.

15. The control method according to claim 12, further comprising multiplying an illuminance value of a region located within a predetermined distance from the vehicle in the image by a first value greater than 1.

16. The control method according to claim 12, further comprising multiplying an illuminance value of an upper region of the image as much as a predetermined first ratio by a second value less than 1.

17. The control method according to claim 12, further comprising determining whether or not each frame of the image has low illuminance based on an emergency light blinking period of the vehicle.

18. The control method according to claim 17, wherein determining whether or not each frame of the image has low illuminance based on the emergency light blinking period of the vehicle comprises:
determining a ratio of frames determined to be low illuminance among a plurality of frames included in a set time prior to a specific frame of the image, wherein the set time is less than or equal to the emergency light blinking period of the vehicle; and
determining whether or not the specific frame has low illuminance based on the determination result.

19. The control method according to claim 18, wherein determining whether or not each frame of the image has low illuminance based on the emergency light blinking period of the vehicle comprises determining that the specific frame has low illuminance when the ratio of frames determined to be low illuminance for the set time prior to the specific frame is equal to or greater than a predetermined second ratio.

20. The control method according to claim 11, wherein setting the ROI comprises setting, as the ROI, a region excluding a region where a body of the vehicle is visible in the image.
